(19) United States
(12) Patent Application Publication
(10) Pub. No.: US 2015/0061889 A1
(43) Pub. Date: Mar. 5, 2015

(54) MOBILE ELECTRONIC DEVICE AND DISPLAY CONTROL METHOD

(71) Applicant: Seiko Epson Corporation, Shinjuku-ku (JP)

(72) Inventors: Tadasuke KOTAKI, Matsumoto-shi (JP); Reiko Sato, Azumino-shi (JP)

(21) Appl. No.: 14/471,599

(22) Filed: Aug. 28, 2014

(30) Foreign Application Priority Data
Aug. 30, 2013 (JP) 2013-179099

(51) Int. Cl. G06T 11/20; A63B 71/06; G06F 17/18

(52) U.S. Cl. CPC G06T 11/206; G06F 17/18; A63B 71/0619
USPC 340/870.05

(57) ABSTRACT

A mobile electronic device is worn and used on the wrist of a user who is exercising. History of a recent measured value is displayed on a display, along with a current measured value of exercise data of a display target. The measured value history is displayed as a bar graph showing a statistical value of the measured value during a predetermined unit period by a length of a bar. In the bar graph showing the measured value history, a part corresponding to a predetermined target range is distinctively displayed. The display range of the target range is fixed in a central part of the vertical axis of the bar graph. A scale on the vertical axis is determined according to the numerical value range of this target range.

### BACKGROUND

1. Technical Field

The present invention relates to a mobile electronic device and the like.

2. Related Art

According to the related art, as a mobile electronic device that has a measurement device inside and is worn on the user's arm for use, a diving electronic device called diving watch is known. The diving watch has a bathometer function utilizing a pressure sensor and can show change in water depth in a graph (see, for example, JP-A-2002-116022).

As an example of a mobile electronic device that measures data of a user himself or herself, instead of measuring change in a user's environment such as water depth, a so-called running watch used for running (marathon) or walking is known. The running watch has, within itself, a position measurement device that receives positioning signals of the GPS (Global Positioning System) or the like and calculates the position, and a measurement device such as acceleration sensor, and measures and displays various exercise data such as running speed or running pace. The exercise data is immediate data about a user's own exercise and therefore useful for managing the physical conditions and grasping the pacing in exercise or the like.

However, in the related art, it is common to show various exercise data in the form of numerical values. For example, a technique of constantly updating and showing the current running pace is employed. This technique is advantageous in that the latest running pace can be grasped. However, during which period the running pace is slow or fast cannot be grasped. In an exercise that is carried out continuously for a certain period of time, such as running, simply displaying instantaneous numerical values is insufficient and there is demand for grasping change in numerical values over time. However, none of the existing mobile electronic devices shows change in exercise data over time that is easy to view.

### SUMMARY

An advantage of some aspects of the invention is to display change in user's exercise data over time in a mobile electronic device in a manner that is easy to view.

A first aspect of the invention is directed to a mobile electronic device including: a measurement unit which measures exercise data of a user; a statistical calculation unit which carries out statistical calculation processing on the measured value by the measurement unit, every predetermined unit period, and thus calculates a statistical value; and a display control unit which performs control to display, in time series, a bar graph showing the statistical value by a length of a bar and providing distinctive display of a part corresponding to a predetermined numerical value range.

As another aspect, the invention may be configured as a display control method executed by a mobile electronic device and including: measuring exercise data of a user; carrying out statistical calculation processing on the measured value every predetermined unit period and thus calculating a statistical value; and performing control to display, in time series, a bar graph showing the statistical value by a length of a bar and providing distinctive display of a part corresponding to a predetermined numerical value range.

According to the first aspect and the like, as the bar graph showing the statistical value of the measured value of the user's exercise data is displayed in time series, the user can easily grasp change in the exercise data over time. Also, since the part corresponding to a predetermined numerical value range is distinctively displayed in the bar graph, the user can easily grasp compares, refer to and thus grasp the state of progress on whether target exercise is realized or not.

A second aspect of the invention is directed to the mobile electronic device according to the first aspect, wherein the measurement unit measures at least one of running pace, pitch, stride, and heart rate, as the exercise data.

According to the second aspect, at least one of running pace, pitch, stride, and heart rate is measured and a bar graph showing the statistical value thereof is displayed.

A third aspect of the invention is directed to the mobile electronic device according to the first or second aspect, wherein the electronic device includes a unit period changing unit which changes the unit period.

According to the third aspect, the unit period is changed. Therefore, by freely changing the unit period to a desired unit period, the user can more easily grasp change in the exercise data over time. Here, as the unit period, for example, a period of time of 1 minute or 10 seconds, or an interval (section) of distance such as a lap can be used.

A fourth aspect of the invention is directed to the mobile electronic device according to any of the first to third aspects, wherein the statistical calculation unit calculates one of average value, maximum value, minimum value, and median of the measured value measured during the unit period, as the statistical calculation processing.

According to the fourth aspect, one of average value, maximum value, minimum value, and median of the measured value measured during the unit period is calculated as the statistical calculation processing.

A fifth aspect of the invention is directed to the mobile electronic device according to any of the first to fourth aspects, wherein the mobile electronic device further includes a numerical value range setting unit which sets the numerical value range as a target range of the exercise data, according an operation by the user.

According to the fifth aspect, the numerical value range is set as a target range of the exercise data, according to an operation by the user. Thus, since the user can freely set the numerical value range to be target, convenience is improved further.

A sixth aspect of the invention is directed to the mobile electronic device according to the fifth aspect, wherein the display control unit allocates a part corresponding to the numerical value range to a vertically central portion of a display area of the bar graph, sets a fixed display size in the display area and the part corresponding to the numerical value range, and adjusts the length of the bar graph to be displayed according to the numerical value range.

According to the sixth aspect, the display area of the bar graph is fixed and the target range (numerical value range) is displayed with a fixed display size in the vertically central portion of the display area. The length of the bar graph to be displayed is adjusted according to the numerical value range. Thus, fluctuations in the measured value (statistical value) of the exercise data with respect to the target range (numerical value range) can be grasped more easily.

A seventh aspect of the invention is directed to the mobile electronic device according to any of the first to sixth aspects of the invention, wherein an area proportion of a display area where the bar graph is displayed, to an entire display area of a display unit provided in the mobile electronic device, is 15 to 25%.

According to the seventh aspect, the area proportion of the display area where the bar graph is displayed may be 10 to 30%, which is relatively small, to the entire display area of the display unit provided in the mobile electronic device. However, since the bar graph is used, change in the exercise data over time can be displayed in an easily understandable manner even in the relative small display area. In a running watch worn on the wrist, if the area proportion of the display area where the bar graph is displayed is set to less than 10% of the entire display area of the display unit provided in the mobile electronic device, it is difficult to visually recognize change in the exercise data over time while exercising. Meanwhile, if the area proportion of the display area where the bar graph is displayed is set to more than 30%, it is difficult to visually recognize other displayed items (for example, the current measured value).

### BRIEF DESCRIPTION OF THE DRAWINGS

The invention will be described with reference to the accompanying drawings, wherein like numbers reference like elements.

FIG. 1 shows the configuration of a mobile electronic device.

FIGS. 2A and 2B show an example of a display screen on the mobile electronic device.

FIG. 3 shows the functional configuration of the mobile electronic device.

FIG. 4 shows an example of the data configuration of measured data.

FIG. 5 shows an example of the data configuration of measured value history display setting data.

FIG. 6 is a flowchart of measured value history display control processing.

### DESCRIPTION OF EXEMPLARY EMBODIMENTS

### Configuration

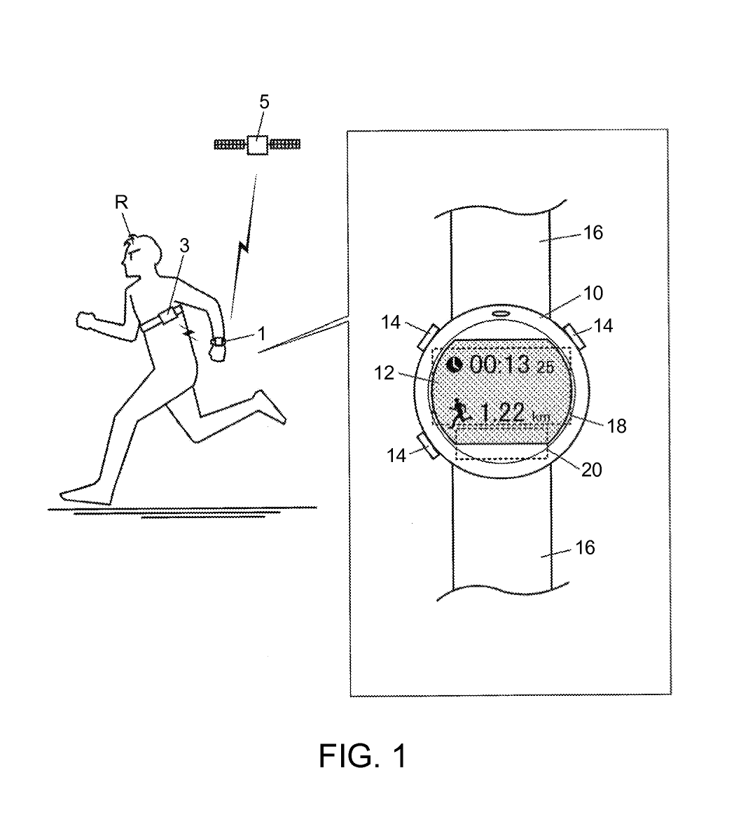

FIG. 1 shows an example of the configuration of a mobile electronic device 1 according to this embodiment. The mobile electronic device 1 is a wearable computer called a running watch which is wearable on the wrist or arm of a user R like a wristwatch.

On the upper surface of a main frame 10 of the mobile electronic device 1, a display 12 which displays time and various exercise data (training data) is provided. On the lateral sides of the main frame 10, an operation switch 14 for the user R to carry out various operation inputs and a band 16 for attaching the mobile electronic device 1 on the wrist or arm of the user R are provided.

The main frame 10 forms an airtight chamber, in which a control board 18 electrically connected to the display 12 and to the operation switch 14 or the like, and a rechargeable battery 20 supplying power to the control board 18 or the like are arranged.

On the control board 18, a CPU (central processing unit), a main memory, a measured data memory, an acceleration sensor, a position measurement module and a short-range wireless communication module are installed. The main memory is a storage medium which stores a program, initial setting data and the result of calculation by the CPU, and includes a RAM (random access memory), ROM (read only memory), flash memory or the like. The measured data memory is a storage medium which stores various measured data and includes a data-rewritable non-volatile memory such as flash memory, FeRAM (ferroelectric random access memory) or MRAM (magnetoresistive random access memory).

The position measurement module receives a signal provided from a position measurement system and generates and outputs position measurement information on a predetermined cycle (every second). In this embodiment, the GPS is used as the position measurement system. That is, the position measurement module includes a known GPS module and GPS receiver. The position measurement information includes positioning date (UTC (coordinated universal time), position coordinates expressed by latitude and longitude, speed and the like. The system used for position measurement is not limited to the GPS and other satellite navigation systems may also be used.

As a charging method for the rechargeable battery 20, for example, the mobile electronic device 1 may be set on a cradle connected to a household power supply and may be charged via an electric contact provided on the back side of the main frame 10 and the cradle. Alternatively, wireless charging may be employed.

The user R wears the mobile electronic device 1 on the wrist and carries out exercise (for example, running). Then, the mobile electronic device 1 measures, accumulates and stores various exercise data (training data) such as running distance and running speed, based on the position measurement information by the built-in position measurement module and the measured value by the built-in acceleration sensor.

If the user R wears an HR (heart rate) sensor 3, the mobile electronic device 1 can additionally measure, accumulate and store the heart rate (HR) as exercise data. The HR sensor 3 is a heart rate monitor which is worn by being wound on the left chest of the user R with an attached band and measures the heart rate (HR) of the user R on a predetermined cycle (for example, a second). The HR sensor 3 also includes a short-range wireless communication module and constantly transmits the data of the measured heart rate to the mobile electronic device 1.

### Display Screen

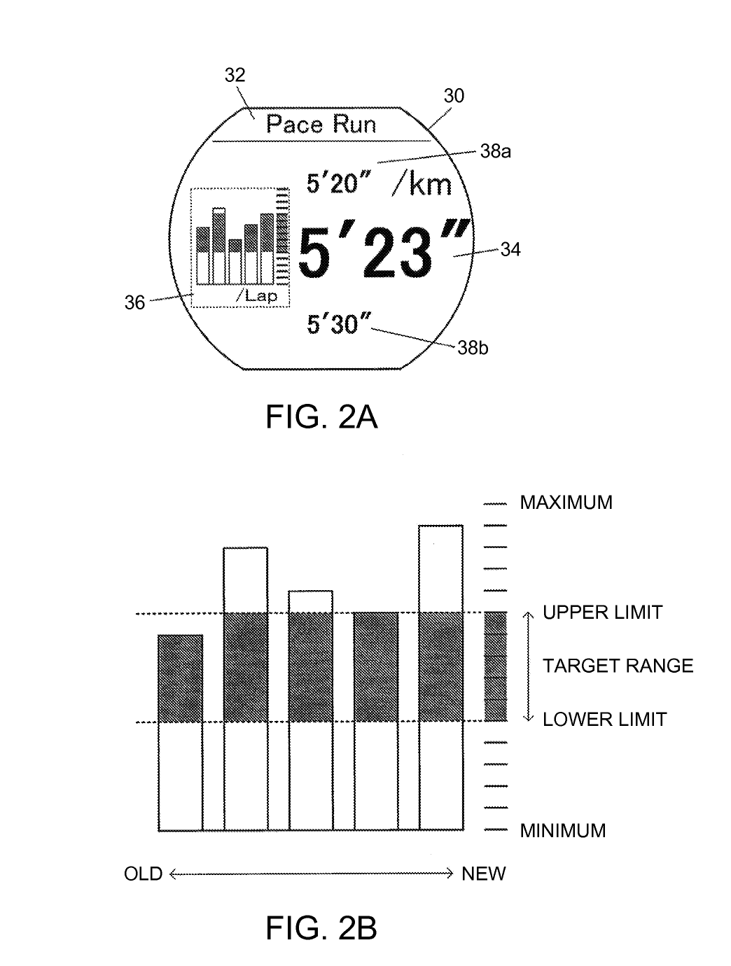

On the display 12 of the mobile electronic device 1, the measured exercise data of the user R is displayed, as shown in FIGS. 2A and 2B. In this embodiment, the exercise data includes four types of data of running pace that is the running time per unit distance (for example, 1 km), pitch that is the number steps per second, stride that is the running distance per step (step length), and heart rate. Although the mobile electronic device 1 constantly measures each of these exercise data, the measured value of one of these plural types of exercise data is displayed on the display 12. The type of exercise data to be displayed can be switched by the user's instruction operation (operation of the operation switch 14). In FIGS. 2A and 2B, the measured value of the running pace is displayed as the exercise data.

As shown in FIG. 2A, along with an exercise data type 32 to be displayed, a current measured value 34 thereof and recent measured value history 36 are displayed on the display screen.

The measured value history 36 is displayed as a vertical bar graph showing a statistical value of the exercise data by the length thereof, as shown in the enlarged view of FIG. 2B. The horizontal axis of this vertical bar graph represents a predetermined unit period. The statistical value is a value resulting from predetermined statistical calculation processing on the measured value taken during this unit period. The statistical calculation processing in this embodiment is the calculation of an average value. However, other kinds of statistical calculation processing may also be employed, such as calculating one of maximum value, minimum value, and median. As the measured value history 36, the statistical value of each of plural (in FIG. 2B, “five”) consecutive unit periods is displayed in time series (in FIG. 2B, in the rightward direction).

The unit period is defined as a time range such as one minute or ten seconds, or a distance range (section) such as a lap. The unit period can be switched by the user's instruction operation (operation of the operation switch 14).

In the bar graph, a part corresponding to a predetermined target range is distinctively displayed. In FIGS. 2A and 2B, this part is shown as gray area and inverted to black on the display screen. Thus, the target range is distinctively displayed. The display range of the target range, that is, the set range (allocated range) to the scale on the vertical axis is fixed at a central part of the vertical axis. The scale on the vertical axis is determined according to the numerical value range indicated by this target range. If the statistical value to be displayed is above the maximum value on the vertical axis or below the minimum value, the bar graph is displayed in such a way as to show that the statistical value is the maximum value or minimum value.

That is, in FIGS. 2A and 2B, the vertical axis has 15 marks on the scale and the five marks in the center are fixedly defined as a target range. The target range of running pace is a numerical value range of 10 seconds, from 5 minutes, 20 seconds (upper limit: meaning the upper limit of running pace, that is, short time and high speed) to 5 minutes, 30 seconds (lower limit: meaning the lower limit of running pace, that is, long time and low speed). One mark on the vertical axis is equivalent to two seconds. Therefore, the numerical value range of the entire vertical axis ranges from 5 minutes, 10 seconds (maximum as display scale: high running pace) to 5 minutes, 40 seconds (minimum as display scale: low running pace).

The upper limit value and the lower limit value of the target range are shown as numerical values at top right part 38a and bottom right part 38b of the measured value history 36 on the display screen. On the display screen, the unit period is shown as a text at the bottom part of the vertical bar graph. In the example of FIG. 2A, the unit period is a lap and the statistical value of running pace in each of the recent five laps is displayed as the measured value history 36.

The numerical value range to be the target range can be arbitrarily set by the user's instruction operation (operation of the operation switch 14). According to the setting of the target range, the scale on the vertical axis of the vertical bar graph is automatically adjusted.

The display area of the measured value history 36 has a predetermined proportion within 15 to 25% with respect to the entire display area on the display 12, and occupies a relatively small proportion of the entire display screen. However, the measured value history 36 is displayed as a bar graph showing the statistical value (average) during the unit period, instead of the measured value itself. Therefore, the user can instantly grasp change in the measured value of the exercise data. Also, since the part corresponding to the target range of measured value is distinctively displayed in the bar graph, the user can easily compare, refer to and grasp the state of progress on whether target exercise is realized or not.

### Functional Configuration

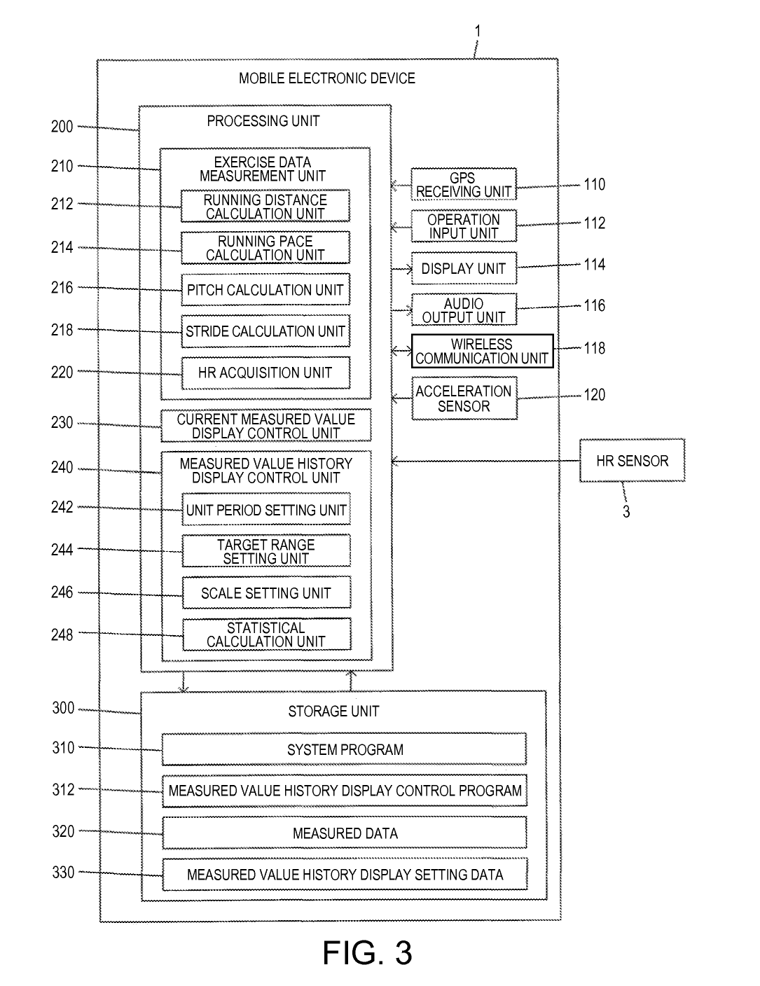

FIG. 3 is a block diagram showing the functional configuration of the mobile electronic device 1. As shown in FIG. 3, the mobile electronic device 1 includes an operation input unit 112, a display unit 114, an audio output unit 116, a wireless communication unit 118, a GPS receiving unit 110, an acceleration sensor 120, a processing unit 200, and a storage unit 300.

The operation input unit 112 is realized by an input device such as button switch, touch panel, various sensors or the like, and outputs an operation signal corresponding to an operation that is done, to the processing unit 200. In FIG. 1, the operation switch 14 is equivalent to this.

The display unit 114 is realized by a display device such as LCD and carries out various displays based on display signals from the processing unit 200. In FIG. 1, the display 12 is equivalent to this.

The audio output unit 116 is realized by an audio output device such as speaker and varies out various audio outputs based on audio signals from the processing unit 200.

The wireless communication unit 118 is realized by a communication device such as wireless LAN (local area network) or Bluetooth (trademark registered) and carries out communication with an external device. In FIG. 1, the wireless communication module installed on the control board 18 is equivalent to this.

The GPS receiving unit 110 receives GPS signals sent from GPS satellites and generates position measurement information including time and date information and position information, every predetermined time (for example, every second). In FIG. 1, the position measurement module is equivalent to this.

The processing unit 200 is realized by a microprocessor such as CPU or GPU and by electronic components such as ASIC (application specific integrated circuit) and IC memory. The processing unit 200 executes various kinds of calculation processing based on programs and data stored in the storage unit 300 and operations signals or the like from the operation input unit 112 and controls the operation of the mobile electronic device 1. In FIG. 1, the CPU installed on the control board is equivalent to this. The processing unit 200 also has an exercise data measurement unit 210, a current measured value display control unit 230, and a measured value history display control unit 240.

The exercise data measurement unit 210 has a running distance calculation unit 212, a running pace calculation unit 214, a pitch calculation unit 216, a stride calculation unit 218, and an HR acquisition unit 220, and measures exercise data of the user R. The measured value of the exercise data by the exercise data measurement unit 210 is accumulated and stored as measured data 320.

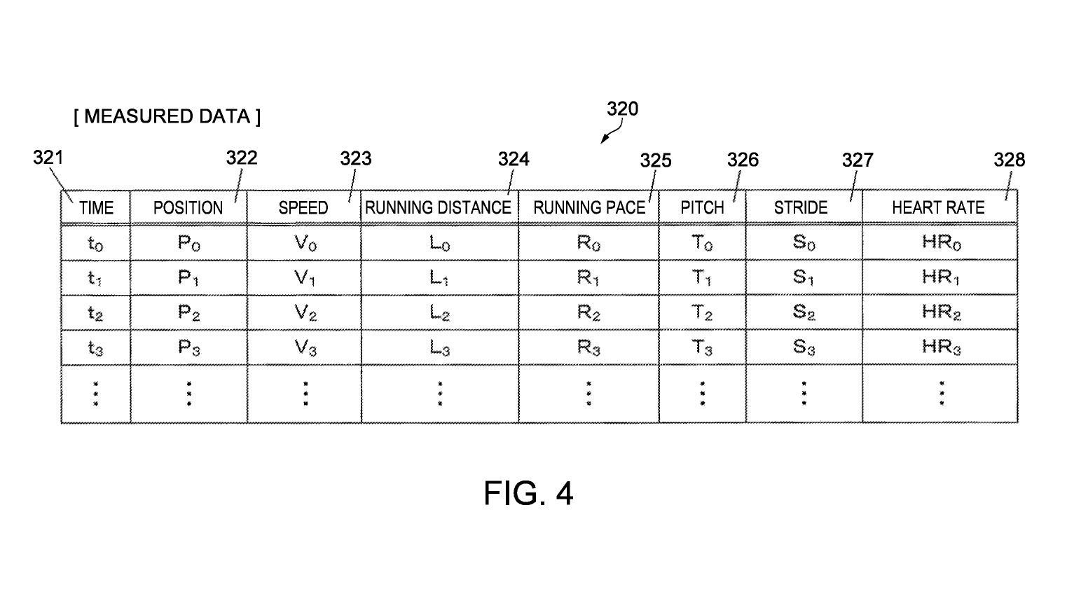

FIG. 4 shows an example of the data configuration of the measured data 320. According to FIG. 4, the measured data 320 stores a position 322, a speed 323, a running distance 324, a running pace 325, a pitch 326, a stride 327 and a heart rate 328 associated with each time 321. The time 321, the position 322 and the speed 323 are acquired from the position measurement information obtained by the GPS receiving unit 110.

The running distance calculation unit 212 calculates the running distance 324 of the user R, based on the position measured information acquired by the GPS receiving unit 110. Specifically, every time the position measurement information is acquired, the difference between the position at the time of the current acquisition and the position at the time of the previous acquisition is calculated and the difference is added to the previous running distance to update the running distance. Thus, the running distance 324 is calculated.

The running pace calculation unit 214 calculates the running pace 325, which is one of the exercise data. Specifically, the time required for the recent running over a predetermined distance (for example, 1 km) is calculated as the running pace 325, referring to the measured data 320 and based on the time 321 and the running distance 324.

The pitch calculation unit 216 detects the landing of “one step” based on a detection value of the acceleration sensor 120, and calculates the pitch 326 with reference to the time 321.

The stride calculation unit 218 detects the landing of “one step” based on a detection value of the acceleration sensor 120, and calculates the stride 327 with reference to the running distance 324.

The HR acquisition unit 220 acquires the heart rate 328, which is one of the exercise data. Specifically, the heart rate 328 transmitted from the HR sensor 3 is acquired. The mobile electronic device 1 may also be configured to have a built-in pulse rate sensor which detects the pulse rate by casting infrared rays toward a skin surface from the back side of the casing of the mobile electronic device 1 and then receiving the infrared rays, so that the pulse rate is acquired by this pulse rate sensor.

The current measured value display control unit 230 displays the current measured value of the exercise data of the type that is set as a display target, for example, like the current measured value 34 in FIGS. 2A and 2B. The display target can be changed by an operation of the operation switch 14 by the user R.

The measured value history display control unit 240 has a unit period setting unit 242, a target range setting unit 244, a scale setting unit 246 and a statistical calculation unit 248, and displays history of the measured value of the exercise data of the type that is defined as a display target, for example, like the measured value history 36 in FIGS. 2A and 2B. Here, necessary data for the display of the history of the measured value is stored as measured value history display control data 330.

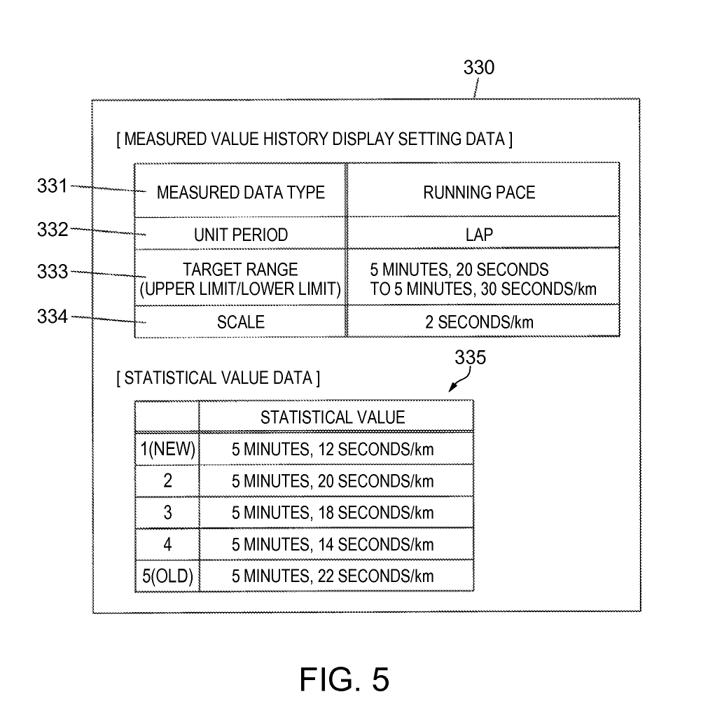

FIG. 5 shows an example of the data configuration of the measured value history display control data 330. According to FIG. 5, the measured value history display control data 330 stores an exercise data type 331 to be a display target of measured value, a unit period 332, a target range 333, a scale 334 and statistical value data 335. The exercise data type 331 is selected, for example, from the running pace 325, the pitch 326, the stride 327 and the heart rate 328 having the measured values thereof stored in the measured data 320. The statistical value data 335 stores the statistical value during each of a predetermined number of (in FIG. 5, “five”) consecutive unit periods, in time series.

The unit period setting unit 242 sets the unit period 332 that is a unit for statistical calculation. Specifically, a unit period is set according to the user's selection operation, from among plural types of unit periods (for example, three types of one minute, ten seconds, and a lap) that are prepared in advance. If the user does not carry out any selection operation, a predetermined value (for example, a lap) is set.

The target range setting unit 244 sets the target range 333 of the measured value of the exercise data. Specifically, an upper limit value and a lower limit value of the target range are set according to the user's instruction operation. If the user does not carry out any instruction operation, a predetermined value is set.

The scale setting unit 246 sets a numerical value (scale) allocated to each mark in the vertical bar graph. Specifically, the numerical value range set as the target range 333 by the target range setting unit 244 is divided by the number of marks that is defined as the display range of the target range, thus setting the numerical value per mark. Based on the decided numerical value per mark, a maximum value/minimum value of the numerical range on the vertical axis of the vertical bar graph is set.

The statistical calculation unit 248 carries out predetermined statistical calculation with the measured value during the unit period 322 and thus calculates the statistical value for each unit period. The statistical calculation is to calculate, for example, an average value, maximum value, minimum value, median or the like. Any value may be calculated.

The storage unit 300 is realized by a storage device such as ROM, RAM or hard disk. The storage unit 300 stores programs and data or the like for the processing unit 200 to integrally control the mobile electronic device 1. Also, the storage unit 300 is used as a work area for the processing unit 200, and the result of the calculation executed by the processing unit 200 and operation data or the like from the operation input unit 112 are temporarily stored in the storage unit 300. In FIG. 1, the main memory and the measured data memory mounted on the control board 18 are equivalent to this. In this embodiment, a measured value history display control program 312, the measured data 320 and the measured value history display control data 330 are stored in the storage unit 300.

### Processing Flow

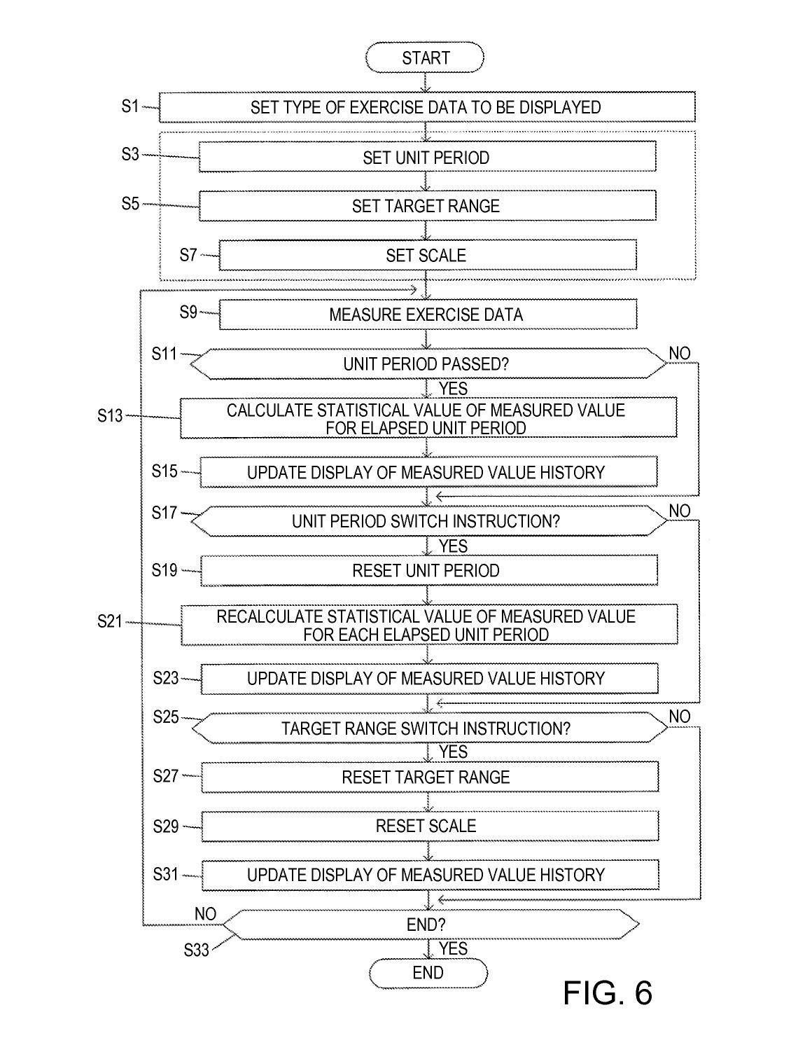

FIG. 6 is a flowchart for explaining a flow of measured value history display control processing. This processing is executed by the measured value history display control unit 240 according to the measured value history display control program 312.

First, before exercise is started, the exercise data type 331 to be a display target is set according to a selection operation by the user R (Step S1). Next, initial setting for displaying history of measured value is carried out. That is, the unit period setting unit 242 sets the unit period 332 according to a selection operation by the user R (Step S3). Also, the target range setting unit 244 set the target range 333 according to a selection operation by the user R (Step S5). Subsequently, the scale setting unit 246 sets the scale 334 (numerical value per mark) according to the target range 333 that is set (Step S7).

As the initial setting ends, the exercise by the user R is started. During the exercise by the user R, exercise data is measured by the exercise data measurement unit 210 (Step S9). Also, every time the unit period 332 passes (Step S11: YES), the statistical calculation unit 248 carries out statistical calculation with the measured value during the elapsed unit period 332 and thus calculates a statistical value (Step S13). The measured value history display control unit 240 updates the display of the measured value history 36 on the display unit 114, based on the calculated statistical value (Step S15).

If a switch instruction for the unit period 332 is given by the user (Step S17: YES), the unit period setting unit 242 resets the unit period 332 according to the user's operation instruction (Step S19). Then, every time the reset unit period 332 passes, statistical calculation is carried out with the measured value to recalculate a statistical value (Step S21). Based on the recalculated statistical value, the display of the measured value history 36 is updated (Step S23).

If a switch instruction for the target range 333 is given by the user (Step S25: YES), the target range setting unit 244 resets the target range 333 according to the user's operation instruction (Step S27). Then, the scale setting unit 246 resets the scale 334 (numerical value range per mark) according to the reset target range 333 (Step S29). The measured value history 36 is updated according to the reset target range 333 (Step S31).

Subsequently, it is determined whether to end the display of the measurement history or not due to the user's end instruction or the like. If the display is not to end (Step S33: NO), the processing returns to Step S9 and similar processing is repeated. If the display is to end (Step S33: YES), this processing ends.

### Advantageous Effects

In this way, the mobile electronic device 1 of this embodiment is worn and used on the wrist of the user R who is exercising. The measured value history 36 of the recent measure value is displayed on the display 12, along with the current measured value 34 of the exercise data of the display target. The measured value history 36 is displayed as a bar graph showing the statistical value of the measured value during the predetermined unit period 332 by the length of the bar. Thus, the user R can easily grasp change in the exercise data over time.

Also, in the bar graph showing the measured value history 36, a part corresponding to the predetermined target range 333 is distinctively displayed. The display range of the target range 333 is fixed at a central part of the vertical axis of the bar graph, and the scale on the vertical axis is determined according to the numerical value range of the target range 333. Thus, the user can easily compare, refer to and grasp the state of progress on whether target exercise is realized or not.

### Modification

The mobile electronic device 1 is described as a wristwatch type worn on the wrist. However, as a matter of course, other forms can also be employed. For example, the mobile electronic device 1 may be a smartphone and the configuration of the embodiment may be arranged inside the smartphone. In such a case, the mobile electronic device 1 may be worn on the upper arm of the user R with a belt or the like. The mobile electronic device 1 may also be configured as smart glasses.

The entire disclosure of Japanese Patent Application No. 2013-179099, filed Aug. 30, 2013 is expressly incorporated by reference herein.

What is claimed is:

1. An electronic device comprising:
a measurement unit which measures exercise data of a user;
a statistical calculation unit which carries out statistical calculation processing on a measured value by the measurement unit and thus calculates a statistical value; and
a display control unit which performs control to display, in time series, a bar graph showing the statistical value by a length of a bar and providing distinctive display of a part corresponding to a predetermined numerical value range.

2. The electronic device according to claim 1, wherein the measurement unit measures at least one of running pace, pitch, stride, and heart rate, as the exercise data.

3. The electronic device according to claim 1, wherein the statistical calculation processing is carried out every predetermined unit period.

4. The electronic device according to claim 3, comprising a unit period changing unit which changes the unit period.

5. The electronic device according to claim 1, wherein the statistical calculation unit calculates one of average value, maximum value, minimum value, and median of the measured value measured during the unit period, as the statistical calculation processing.

6. The electronic device according to claim 1, further comprising a numerical value range setting unit which sets the numerical value range as a target range of the exercise data, according an operation by the user.

7. The electronic device according to claim 6, wherein the display control unit allocates a part corresponding to the numerical value range to a vertically central portion of a display area of the bar graph, sets a fixed display size in the display area and the part corresponding to the numerical value range, and adjusts the length of the bar graph to be displayed according to the numerical value range.

8. The electronic device according to claim 1, wherein an area proportion of a display area where the bar graph is displayed, to an entire display area of a display unit provided in the electronic device, is 15% or higher and 25% or lower.

9. The electronic device according to claim 1, wherein the distinctive display is a different color from a display color of a part that is not the predetermined numerical value range.

10. The electronic device according to claim 1, wherein the electronic device is mobile.

11. A display control method executed by an electronic device comprising:
measuring exercise data of a user;
carrying out statistical calculation processing on the measured value and thus calculating a statistical value; and
performing control to display, in time series, a bar graph showing the statistical value by a length of a bar and providing distinctive display of a part corresponding to a predetermined numerical value range.
